(19) United States
(12) Patent Application Publication
(10) Pub. No.: US 2011/0000625 A1
(43) Pub. Date: Jan. 6, 2011

(54) MOVABLE PARTITIONS, LEADING END ASSEMBLIES FOR MOVABLE PARTITIONS AND RELATED METHODS

(75) Inventor: Michael D. George, Kaysville, UT (US)

Correspondence Address: TRASKBRITT, P.C., P.O. BOX 2550, SALT LAKE CITY, UT, 84110, US

(73) Assignee: WON-DOOR CORPORATION, Salt Lake City, UT (US)

(21) Appl. No.: 12/497,310

(22) Filed: Jul. 2, 2009

(51) Int. Cl. E06B 3/94; E06B 3/48; E05D 15/26; E05F 15/02; E04B 1/00

(52) U.S. Cl. 160/84.02; 160/181; 160/206; 49/27; 52/745.16

(57) ABSTRACT

A leading end assembly for a movable partition may include a jamb plate for coupling the leading end assembly to at least one panel of a movable partition and a leading end cover coupled to the jamb plate and being movable relative to the jamb plate. The leading end assembly may include an at least substantially planar leading surface having a size and shape configured to at least substantially cover an opening to a storage pocket for a movable partition. A movable partition assembly may include a leading end structure configured to at least substantially cover an opening to a storage pocket. Methods of installing a movable partition assembly include forming a leading end structure to at least substantially cover an opening to a storage pocket. Methods of using a movable partition include covering an opening to a storage pocket with a leading end structure coupled to the movable partition.

### TECHNICAL FIELD

Embodiments of the present invention are directed to leading end assemblies for movable partitions, movable partition assemblies including leading end assemblies, methods of installing a movable partition assembly in a building, and methods of using a movable partition.

### BACKGROUND

Movable partitions are utilized in numerous situations and environments for a variety of purposes. Such partitions may include, for example, a movable partition comprising foldable or collapsible doors configured to enclose or subdivide a room or other area. Often such partitions may be utilized simply for purposes of versatility in being able to subdivide a single large room into multiple smaller rooms. The subdivision of a larger area may be desired, for example, to accommodate multiple groups or meetings simultaneously. In other applications, such partitions may be utilized for noise control depending, for example, on the activities taking place in a given room or portion thereof.

Movable partitions may also be used to provide a security barrier, a fire barrier, or both a security barrier and a fire barrier. In such a case, the partition barrier may be configured to automatically close upon the occurrence of a predetermined event such as the actuation of an associated alarm. For example, one or more accordion or similar folding-type partitions may be used as a security barrier, a fire barrier, or both a security barrier and a fire barrier wherein each partition is formed with a plurality of panels connected to one another with hinges. The hinged connection of the panels allows the partition to fold and collapse into a compact unit for purposes of storage when not deployed. The partition may be stored in a pocket formed in the wall of a building when in a retracted or folded state. When the partition is deployed to subdivide a single large room into multiple smaller rooms, secure an area during a fire, or for any other specified reason, the partition may be extended along an overhead track, which is often located above the movable partition in a header assembly, until the partition extends a desired distance across the room.

When deployed, a leading end of the movable partition, often defined by a component known as a lead post, complementarily engages a receptacle in a fixed structure, such as a wall, or in a mating receptacle of another door. Such a receptacle may be referred to as a jamb or a door post when formed in a fixed structure, or as a mating lead post when formed in another movable partition. It is desirable that the lead post be substantially aligned with the mating receptacle such that the movable partition may be completely closed and an appropriate seal formed between the movable partition and the mating receptacle.

FIG. 1 illustrates an example of a movable partition system 10 currently known in the art. The partition system 10 comprises a movable partition 12 which mates with a stationary structure to form a barrier. As shown in FIG. 1, a movable partition 12 includes a male lead post 14 which is configured to mate with a female door post 16 formed in a wall 18. The accordion-style movable partition 12 includes a first accordion-style structure 20A and a second accordion-style structure 20B which is laterally spaced from, and substantially parallel with, the first structure 20A. Each of the two structures 20A and 20B has a first end 22 structurally fixed to a floating jamb 24 which is movable within a pocket 26 and a second end 28 which is attached to the lead post 14. Such a configuration may be used as a sound barrier or fire barrier wherein the first partition 20A acts as a primary barrier, the second partition 20B acts as a secondary barrier, and the space between the two partitions 20A and 20B acts as an insulator or a buffer zone.

When the movable partition 12 is in a retracted state, the movable partition 12 is stored in the pocket 26. The pocket 26 includes a pocket door 30 covering an open end of the pocket 26 when the movable partition 12 is in a retracted state. When the movable partition 12 is moved to an extended state, the pocket door 30 is opened and the movable partition 12 is extended along an overhead track (not shown) toward the female door post 16 formed in the wall 18. The pocket door 30 is hingedly coupled to a portion of the pocket 26 such that the pocket door 30 may swing away from the pocket 28 when the movable partition 12 is extended along the overhead track. In a fully extended state, the male lead post 14 of the movable partition 12 is received within the female door post 16 and the movable partition 12 may be latched or otherwise secured to female door post 16 in the extended state.

### BRIEF SUMMARY

In accordance with some embodiments of the present invention, a leading end assembly for a movable partition may include a jamb plate for coupling the leading end assembly to at least one panel of a movable partition and a leading end cover coupled to the jamb plate. The leading end cover may cover at least a portion of a leading surface of the jamb plate and may be movable relative to the jamb plate between a first position and a second position. The leading end cover may be biased to the first position. The leading end assembly may also include a sensor configured to sense when the leading end cover is moved from the first position to the second position.

In additional embodiments, the present invention includes a leading end assembly for a movable partition including an at least substantially planar leading surface having a size and shape that may be configured to at least substantially cover an opening to a storage pocket for a movable partition to which the leading end assembly is to be coupled.

In yet additional embodiments, the present invention includes a movable partition assembly having two walls extending between a floor and a ceiling and defining a storage pocket therebetween. A movable partition may be at least partially disposed within the storage pocket and a leading end structure may be coupled to an end of the movable partition. The leading end structure may include a leading surface having a size and shape configured to at least substantially cover an opening to the storage pocket when at least substantially all of the movable partition is in a storage position within the storage pocket.

In yet additional embodiments, the present invention includes a method of installing a movable partition assembly in a building including constructing two opposing and at least generally parallel walls extending between a floor and a ceiling to define a storage pocket therebetween and positioning at least a trailing end of a movable partition within the storage pocket. The method may also include forming a leading end structure and sizing and shaping a leading surface of the leading end structure to at least substantially cover an opening to the storage pocket and attaching the leading end structure at a leading end of the movable partition.

In yet additional embodiments, the present invention includes a method of using a movable partition including storing a movable partition at least substantially entirely within a storage pocket and at least substantially entirely covering an opening to the storage pocket with a leading end structure coupled to a leading end of the movable partition.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be more readily ascertained from the description of embodiments of the invention when read in conjunction with the accompanying drawings, in which:

FIG. 1 is a partial cross-sectional view of a movable partition system;

FIG. 2 is a perspective view of an embodiment of a movable partition system of the present invention including a leading end assembly as described herein;

FIG. 3 is a partial cross-sectional view of the movable partition system of FIG. 2 shown in a retracted state;

FIG. 4 is a partial cross-sectional view of the movable partition system of FIG. 2 shown in an extended state;

FIG. 5 is a partial cross-sectional view of another embodiment of a leading end assembly for a movable partition system;

FIG. 6 is a partial cross-sectional view of yet another embodiment of a leading end assembly for a movable partition system; and

FIG. 7 is a partial cross-sectional view of yet another embodiment of a leading end assembly for a movable partition system including a latching feature.

### DETAILED DESCRIPTION

Illustrations presented herein are not meant to be actual views of any particular device or system, but are merely idealized representations which are employed to describe embodiments of the present invention. Additionally, elements common between figures may retain the same numerical designation.

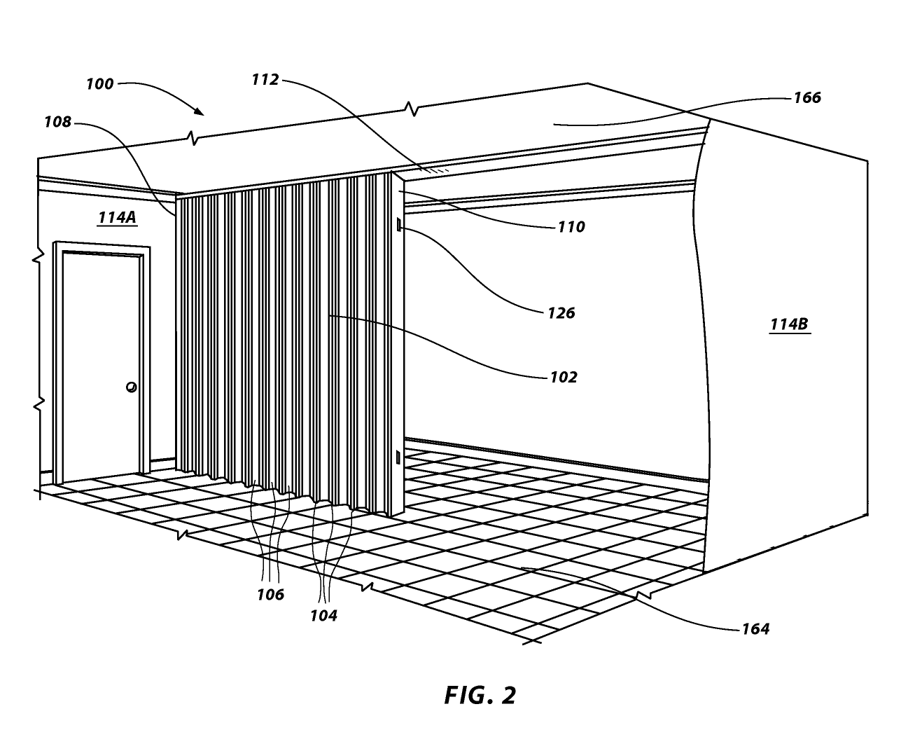

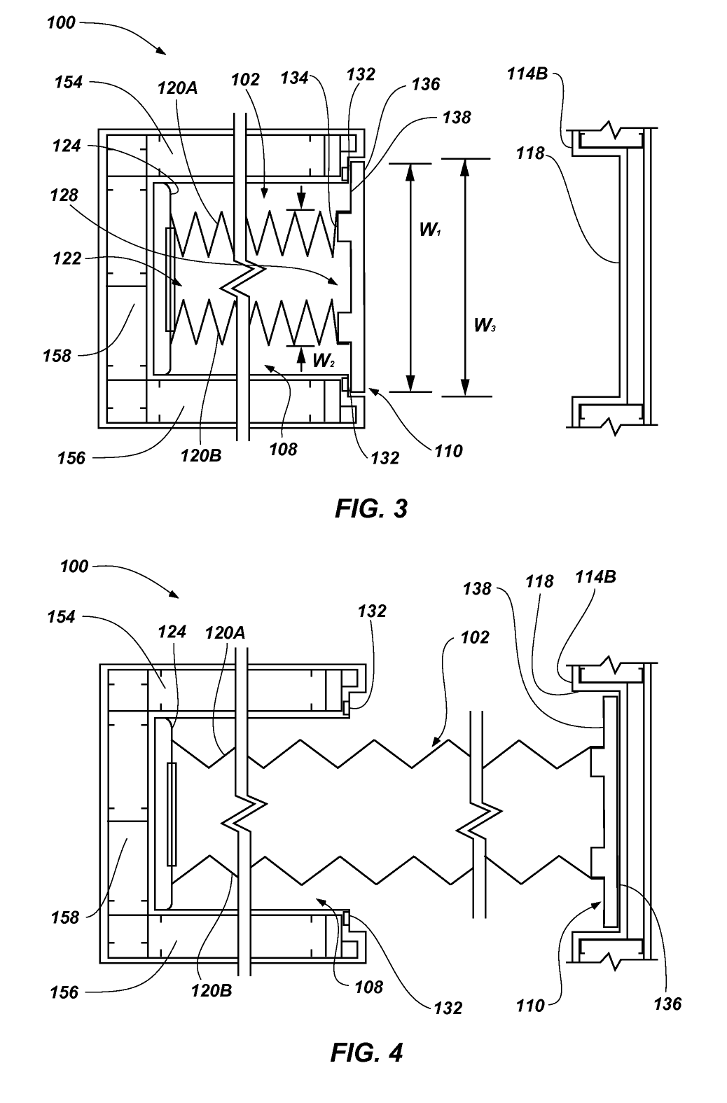

Referring to FIG. 2, a system 100 is shown, which may also be referred to as a movable partition system 100, including a movable partition 102 in the form of an accordion-type door. The movable partition 102 may be used as a barrier (e.g., a security barrier, a fire barrier, or both a security barrier and a fire barrier). In other embodiments, the movable partition 102 may be used, for example, to subdivide a relatively larger space into relatively smaller spaces (e.g., rooms or areas). The movable partition 102 may be formed with a plurality of panels 104 that are connected to one another with hinges or other hinge-like members 106 to form a pleated (i.e., a plicated) structure. The movable partition 102 is engaged with (e.g., suspended from) an overhead track 112 along which the movable partition 102 moves as the movable partition 102 is extended (i.e., closed) and retracted (i.e., opened). The hinged connection of the panels 104 allows the movable partition 102 to be compactly stored in a movable partition storage area such as, for example, a storage pocket 108 formed in a wall 114A of a building when in a retracted or folded state. As described below, in some embodiments, the pocket 108 may be formed by a first wall 154 and a second wall 156 (FIG. 3) extending between a floor 164 and a ceiling 166.

To deploy the movable partition 102 to an extended position, the movable partition 102 is moved along the overhead track 112. A leading end structure of the movable partition 102 may include a leading end assembly 110 configured to engage with an adjoining structure such as, for example, a door jamb or a leading end assembly of another movable partition (not shown). The door jamb may be provided in an opposing wall 114B of a building to which the movable partition 102 may extend in an extended state. While the embodiment of the movable partition 102 shown and described with reference to FIG. 2 contains a single accordion-type door, additional embodiments of the present invention may include multiple doors. For example, a partition may include two doors (e.g., accordion-type doors) configured to extend across a space and join together to partition a space.

Referring to FIG. 3, the movable partition system 100 is shown in a partial cross-sectional view. As shown in FIG. 3, a movable partition system 100 may comprise an accordion-style movable partition 102 that may include a first accordion-style structure 120A and a second accordion-style partition 120B which is laterally spaced from, and extends generally parallel to, the first structure 120A. Each of the two structures 120A and 120B has a trailing end 122 structurally fixed to a jamb such as, for example, a floating jamb 124 which is movable within the pocket 108 and a leading end 128 which is attached to the leading end assembly 110.

When the movable partition 102 is in a retracted state, the movable partition 102 may be stored in the pocket 108 formed by one or more walls. For example, as shown in FIG. 3, the pocket 108 may be provided by a first wall 154 and a second wall 156. The walls 154, 156 may extend substantially parallel to each other and may extend between a floor 164 and a ceiling 166 (FIG. 2) to form the pocket 108. In some embodiments, the pocket 108 may also be provided by a rear wall 158 extending between the walls 154, 156.

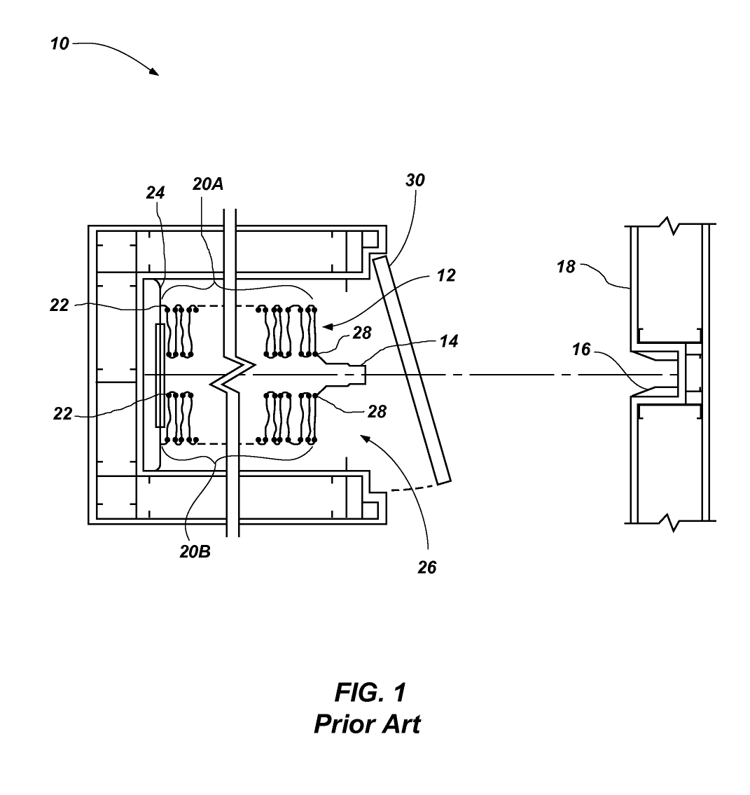

The movable partition system 100 does not include a pocket cover like the pocket door 30 shown in FIG. 1. The movable partition 102 may include a leading end assembly 110. The leading end assembly 110 may comprise leading portion such as, for example, a leading surface 136 that may abut with an adjoining structure such as, for example, a doorjamb 118 or the leading end assembly of another movable partition (not shown). As used herein, “leading surface” means a distal surface of the leading end assembly 110 (e.g., the surface of an element located furthest from the point of attachment with the movable partition 102). The leading end assembly 110 may further comprise a trailing portion such as, for example, a trailing surface 138 positioned opposite to the leading surface 136. As used herein, “trailing surface” means a proximal surface of the leading end assembly 110 (e.g., the surface of an element located at the point of attachment with the movable partition 102).

In some embodiments, the leading surface 136 may be substantially flat and may abut with the door jamb 118. As discussed below, in some embodiments, the leading end assembly 110 may comprise a latching feature to secure the leading end assembly 110 with the doorjamb 118. It is noted that while the doorjamb 118 shown and described with reference to FIG. 3 is illustrated as a shallow pocket structure, the doorjamb 118 may be any suitable shape and configuration, including a substantially flat surface of an adjoining structure wherein the leading surface 136 of the leading end assembly 110 may abut with the substantially flat surface of the adjoining structure.

The leading end assembly 110 may include an attachment portion configured to attach to the movable partition 102. For example, the movable partition 102 may be coupled to an attachment portion of the leading end assembly 110 such as, for example, the trailing surface 138 of the leading end assembly 110. In some embodiments, the trailing surface 138 of the leading end assembly 110 may include protrusions 134 on the trailing surface 138. The protrusions 134 may be any shape suitable to attach the accordion-style structures 120A, 120B such as, for example, a rectangular shape as shown in FIG. 3. An end of the movable partition 102 (e.g., the leading end 128 of the partitions 120A, 120B) may be coupled to the leading end assembly 110. For example, the movable partition 102 may be coupled to the leading end assembly 110 at the protrusions 134 on the trailing surface 138. The movable partition 102 may be coupled to the leading end assembly 110 in any suitable manner including, but not limited to, using adhesives, tongue and groove joints, and fasteners (e.g., screws, bolts, rivets, etc.).

As further shown in FIG. 3, the leading end assembly 110 may be sized to form a barrier at an open end of the pocket 108 (e.g., the end of the pocket 108 through which the movable partition 102 may be extended along the overhead track) when the movable partition 102 is in a retracted state. In some embodiments, the leading end assembly 110 may form a barrier substantially covering the open end of the pocket 108. In some embodiments, the leading surface 136 of the leading end assembly 110 may be substantially flush with a portion of the walls 154, 156 when the movable partition 102 is retracted in a storage position within the pocket 108. The walls 154, 156 forming the pocket 108 may include an abutment feature formed on a portion of the walls 154, 156. For example, seating surfaces 132 located on the walls 154, 156 may abut with the leading end assembly 110 when the movable partition 102 is in a retracted state. As shown in FIG. 3, the seating surfaces 132 may comprise a step formed in the walls 154, 156. When the movable partition 102 is in a retracted state, the lateral sides of the leading end assembly 110 may abut the seating surfaces 132. It is noted that while the embodiment of FIG. 3 illustrates the seating surfaces 132 as integrally formed in the walls 154, 156, the seating surfaces 132 may comprise any suitable abutment feature, including, but not limited to, attachments coupled to the inside of the walls 154, 156 forming the pocket 108 that are not integrally formed in walls 154, 156 or an abutment feature located on the floor 164 or ceiling 166 (FIG. 2) proximate to the open end of the pocket 108. Additionally, in some embodiments, the seating surfaces 132 may further comprise a magnetic material. The magnetic material of the seating surfaces 132 may at least partially secure the leading end assembly 110 to the pocket 108 when the movable partition 102 is in a retracted state.

In some embodiments, the leading end assembly 110 may also be sized to have a lateral width W₁ (i.e., a dimension measured in a direction parallel to the lateral direction of the leading end assembly 110) that is greater than a lateral width W₂ of the movable partition 102 (i.e., a dimension measured parallel to the lateral direction of the movable partition 102 in a direction substantially parallel to the lateral width of the leading end assembly 110). Additionally, in some embodiments, the leading end assembly 110 may have a height (i.e., a dimension measured in a direction parallel to the longitudinal direction of the leading end assembly 110) that is greater than a height of the movable partition 102 (i.e., a dimension measured perpendicular to the longitudinal direction of the movable partition 102 in a direction substantially parallel to the height of the leading end assembly 110). In some embodiments, the leading end assembly 110 may have both a lateral width and height greater than that of the lateral width and height of the movable partition 102.

In some embodiments, the leading end assembly 110 may entirely fill the open end of the pocket 108. For example, the lateral width W₁ leading end assembly 110 may be substantially equal to the lateral width W₃ of the open end of the pocket 108 (i.e., a dimension measured between the walls 154, 156 at the open end of the pocket 108 in a direction substantially parallel to the lateral width of the leading end assembly 110). The height of the leading end assembly 110 may also be substantially equal to the height of the open end of the pocket 108 (i.e., a dimension measured perpendicular to the lateral width W₃ of the open end of the pocket 108 in a direction substantially parallel to the height of the leading end assembly 110).

As shown in FIG. 4, when the movable partition 102 is in an extended state, the movable partition 102 may be extended along an overhead track (not shown) to a surface of the opposing wall 114B such as, for example, the doorjamb 118 formed in the opposing wall 114B. In an extended state, the leading end assembly 110 of the movable partition 102 may be abutted with the door jamb 118 and may be latched or otherwise secured in the extended state as discussed below with reference to FIG. 7. In some embodiments, the leading surface 136 of the leading end assembly 110 may be substantially disposed within the door jamb 118. Further, the leading surface 136 may be abutted to a surface of the door jamb 118 formed in the opposing wall 114B to form a barrier such as, for example, a fire barrier.

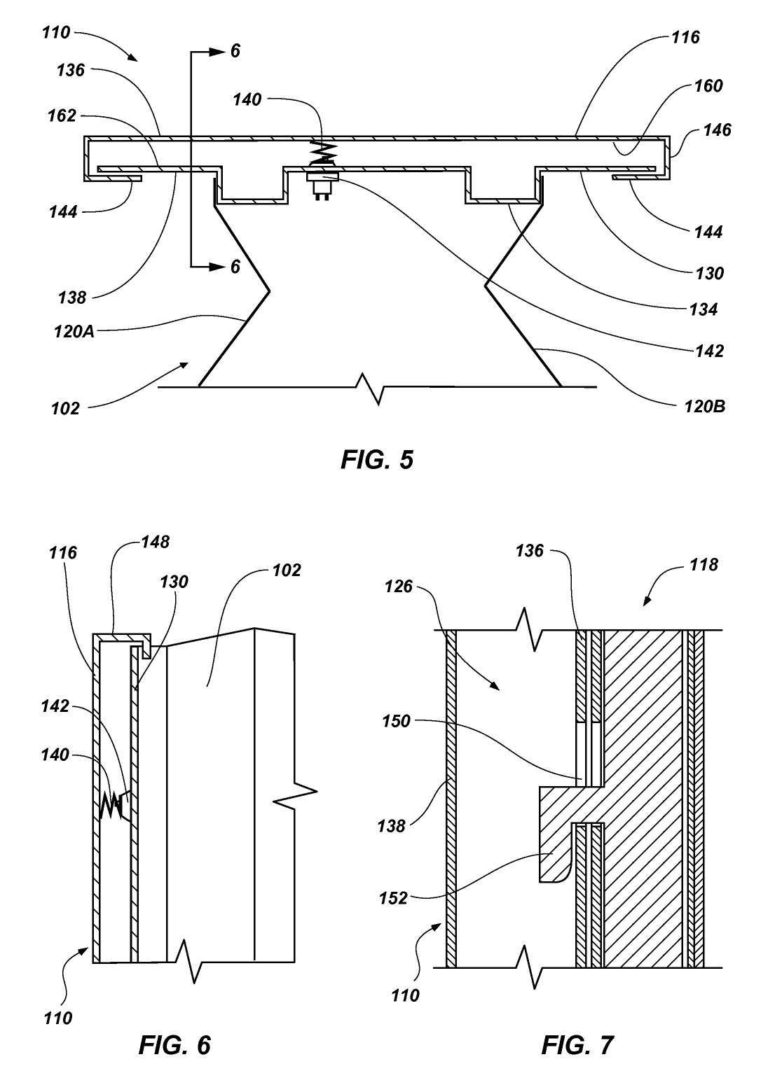

As shown in FIG. 5, in some embodiments, the leading end assembly 110 may include two or more elements which form the leading end assembly 110 such as, for example, a leading end cover 116 and a jamb plate 130. The leading end cover 116 may comprise a first portion of the leading end assembly 110. As shown in FIG. 5, a portion of the leading end cover 116 may form the leading surface 136 of the leading end assembly 110. The leading end cover 116 may also include a substantially C-shaped channel portion 146 formed on the trailing surface 160 of the leading end cover 116 opposing the leading surface 136. In some embodiments, the channel portion 146 may include flange portions 144. Each of the flange portions 144 may be formed on a lateral side of the leading end cover 116 and may partially receive a jamb plate 130 within the flange portions 144. The leading end cover 116 may coupled to the jamb plate 130 and may cover the leading surface 162 of the jamb plate 130. As also shown in FIG. 5, a portion of the jamb plate 130 and a portion of the flange portions 144 of the leading end cover 116 may form the trailing surface 138 of the leading end assembly 110. In some embodiments, the jamb plate 130 may include the protrusions 134 and the movable partition 102 may be coupled to the leading end assembly 110 at the protrusions 134. Each of the flange portions 144 may extend along a side of the leading end cover 116 and may extend along the longitudinal length of the leading end cover 116. The jamb plate 130 may be received within the flange portions 144 and the sides of the jamb plate 130 may partially abut a portion of the flange portions 144 of the leading end cover 116. The leading end cover 116 and the jamb plate 130 may be formed from materials such as, for example, steels (e.g., a 16-gauge steel), metal alloys, composite materials, rigid polymers, etc.

The leading end cover 116 may be movable relative to the jamb plate 130 between a first position and a second position. For example, the jamb plate 130 may be coupled to the leading end cover 116 such that the leading end cover 116 may move from a first position toward the jamb plate 130 to a second position.

Referring still to FIG. 5, the leading end assembly 110 may further include a biasing element (e.g., a spring 140 or springs) disposed between the jamb plate 130 and the leading end cover 116. The spring 140 may bias a portion of the jamb plate 130 into contact with a portion of each of the flange portions 144 of the leading end cover 116. For example, as shown in FIG. 5, the abutting side portions of the leading end cover 116 and jamb plate 130 may be biased into contact with each other. In some embodiments, the spring 140 may bias the leading end cover 116 in the first position such that a force applied to the leading surface 136 of the leading end cover 116 compresses the spring 140 and may separate the abutting side portions of the leading end cover 116 and the jamb plate 130 as the leading end cover 116 moves to the second position.

In some embodiments, the leading end assembly 110 may include a sensor 142. The sensor 142 may sense when the leading end cover 116 is moved from the first position to the second position. In some embodiments, the sensor 142 may be configured to trigger a predetermined event such as, for example, a signal to the control system or motor (not shown) of the movable partition 102 ceasing movement of the movable partition 102. The sensor 142 may be disposed between the leading end cover 116 and jamb plate 130. For example, the sensor 142 may be disposed within the spring 140 such that when the spring 140 is compressed by a force applied to the leading surface 136 of the leading end cover 116, the sensor 142 is triggered.

By the way of example and not limitation, the sensor 142 may be connected to the control system or motor (not shown) of the movable partition 102 and may be configured to cease movement of the motor and, thereby, the movable partition 102 when the sensor 142 is triggered (e.g., when the sensor 142 senses that the leading end cover 116 has moved from the first position to the second position). When the movable partition 102 is being driven by the motor to an expanded state, a force applied to the leading end cover 116 of the leading end assembly 110 may cease the movement of the movable partition 102. For example, an obstruction in the path of movable partition 102 may move the leading end cover 116 from the first position to the second position. The sensor 142 may sense the displacement of the leading end cover 116 and may signal the motor to stop moving the movable partition 102. Similarly, a user of the movable partition 102 may apply a force to the leading end assembly 110 and halt the movement of the movable partition 102.

Referring to FIG. 6, in some embodiments, the leading end assembly 110 may also include an upper flange 148. The upper flange 148 may extend along an upper portion of the leading end cover 116. The upper flange 148, when implemented, may abut with the jamb plate 130 and the jamb plate 130 may support the leading end cover 116. Further, the upper flange 148 may slide over an upper portion of the jamb plate 130 to allow the leading end cover 116 to move in a direction toward the jamb plate 130. For example, when a force is applied to the leading end cover 116 of the leading end assembly 110, the upper flange 148 may slide over the upper portion of the jamb plate 130 and allow the spring 140 to compress and the sensor 142 to be triggered.

Referring now to FIG. 7, in some embodiments, the movable partition 102 (FIG. 2) may include a latching feature formed on the leading end assembly 110, the door jamb 118, or both the leading end assembly 110 and the door jamb 118. As shown in FIG. 7, in some embodiments, the latching feature such as, for example, the latching member 126 may comprise a rectangular slot 150 formed in the leading surface 136 of the leading end assembly 110. The latching member 126 may be configured to receive a latching member (e.g., the latching hook member 152). Such latching mechanisms are disclosed, for example, in U.S. Pat. No. 4,834,161, issued May 30, 1989, entitled “Folding Firedoor Lead Post Assembly” and assigned to the assignee of the present invention, the entire disclosure of which patent is incorporated herein by this reference. As described in the above referenced patent, a weight and pulley system may be configured to latch a movable partition in the extended state with a temperature sensitive latch.

In some embodiments, a temperature sensitive latch may be configured to mechanically latch the movable partition 102 in the extended state when a predetermined temperature is reached. For example, the leading end assembly 110 may include a slot 150 formed in the leading surface 136 of the leading end assembly 110 may abut with a door jamb 118. When the leading surface 136 of the leading end assembly 110 is abutted with the door jamb 118, the latching hook member 152 may be partially received within the leading end assembly 110. The latching hook member 152 may secure the leading end assembly 110 to the door jamb 118 by, for example, moving a latching hook member 152 in a downward direction, thereby, inhibiting the leading end assembly 110 from being moved away from the door jamb 118. In some embodiments and as described in the above referenced patent, the latching hook member 152 may be configured to drop in a downward direction to secure the leading end assembly 110 to the doorjamb 118 when the movable partition 102 or door jamb 118 has reached a predetermined temperature.

It is noted that while the embodiment shown and described with reference to FIG. 7 illustrates a latching feature including a latching hook member 152 and a slot 150 located on the leading surface 136 of the leading end assembly 110, the latching feature may comprise other configurations. For example, the latching feature may be positioned in the sides of the door jamb 118 and may be deployed to abut the trailing surface 138 of the leading end assembly 110 as to inhibit the retraction of the leading end assembly 110 from the door jamb 118. In some embodiments, the leading end assembly 110 may not comprise a latching feature and other methods such as, for example, force applied by the motor (not shown) may be utilized to secure the movable partition 102 in an extended state. In some embodiments, the latching feature may comprise magnetic material formed in the door jamb 118, the leading end assembly 110, or both the doorjamb 118 and the leading end assembly 110. When the magnetic material is coupled together to other magnetic material or to a metal object such as, for example, the leading end assembly 110 or the doorjamb 118, the magnetic material may partially secure the movable partition 102 in the extended state.

Referring again to FIG. 3, a method of installing a movable partition assembly in a building may include constructing two opposing and at least generally parallel walls extending between a floor 164 and a ceiling 166 (FIG. 2) to define a storage pocket 108 therebetween. The trailing end 122 of a movable partition 102 may be positioned within the storage pocket 108. A leading end structure (e.g., the leading end assembly 110) may include a leading surface 136 sized and shaped to at least substantially cover an opening to the storage pocket 108. Further, the leading end assembly 110 may be attached to the leading end 128 of the movable partition 102.

Referring still to FIG. 3, a method of operating a movable partition 102 may include storing the movable partition 102 at a first position in a pocket 108 formed in an adjoining structure and forming a barrier at an open end of the pocket 108 with a leading end assembly 110 coupled to an end of the movable partition 102. The movable partition 102 may be extended to a second position to divide a space and may abut a portion of a door jamb 118 with the leading end assembly 110. In some embodiments, the method may also include abutting at least a portion of two seating surfaces 132 of the open end of the pocket 110 with the leading end assembly 110. In some embodiments, the method may include securing the movable partition 102 in the second position with a latching mechanism such as, for example, the latch 126 (FIG. 7) formed in the leading end assembly 110.

A method of using a movable partition 102 may include storing a movable partition 102 within a storage pocket 108 and covering an opening to the storage pocket 108 with a leading end assembly 110 coupled to a leading end 128 of the movable partition 102.

In view of the above, embodiments of the present invention may be particularly useful providing a leading end assembly for a movable partition. Generally, a separate pocket door cover and associated hardware is required to cover a pocket and the movable partition stored therein when the movable partition is in a retracted state. The separate pocket requires additional installation and, generally, has to be forced open by the movable partition when the movable partition is utilized as an automatic door. In automatic door configurations such as, for example, a fire door, the separate pocket door may damage the movable partition when the pocket door is forced open or if the open pocket door contacts the extended movable partition. Further, the separate door requires the user to close the pocket door once the movable partition has been retracted from its extended state. Accordingly, the leading end assembly may eliminate the need for a separate pocket door cover and hardware to cover the movable partition stored in a retracted state in the pocket. Thus, the leading end assembly may provide a pocket cover and leading end of the partition in one element, thereby, decreasing the size of the movable partition when it is stowed in a retracted state and increasing the ease of installation and use of the movable partition.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, legal equivalents, and alternatives falling within the spirit and scope of the invention as defined by the following appended claims.

1. A leading end assembly for a movable partition comprising:
a jamb plate for coupling the leading end assembly to at least one panel of a movable partition;
a leading end cover coupled to the jamb plate and covering at least a portion of a leading surface of the jamb plate, the leading end cover being movable relative to the jamb plate between a first position and a second position, the leading end cover being biased to the first position; and
a sensor configured to sense when the leading end cover is moved from the first position to the second position.

2. The leading end assembly of claim 1, wherein at least a portion of the leading end cover is substantially flat and at least substantially covers the leading surface of the jamb plate.

3. The leading end assembly of claim 1, wherein the leading end cover has a size and shape configured to at least substantially entirely fill an opening to a storage pocket for a movable partition.

4. The leading end assembly of claim 1, further comprising at least one spring disposed between the jamb plate and the leading end cover, the at least one spring biasing the leading end cover to the first position.

5. A leading end assembly for a movable partition comprising an at least substantially planar leading surface having a size and shape configured to at least substantially cover an opening to a storage pocket for a movable partition to which the leading end assembly is to be coupled.

6. A movable partition assembly comprising:
two walls extending between a floor and a ceiling and defining a storage pocket therebetween;
a movable partition at least partially disposed within the storage pocket; and
a leading end structure coupled to an end of the movable partition, the leading end structure comprising a leading surface having a size and shape configured to at least substantially cover an opening to the storage pocket when at least substantially all of the movable partition is in a storage position within the storage pocket.

7. The partition assembly of claim 6, wherein the leading surface of the leading end structure is at least substantially planar.

8. The partition assembly of claim 6, wherein the leading end structure comprises:
a jamb plate coupled to the end of the movable partition; and
a leading end cover disposed on a side of the jamb plate opposite the movable partition, the leading end cover being movable relative to the jamb plate and comprising the leading surface.

9. The partition assembly of claim 8, wherein the leading surface of the leading end cover is at least substantially planar.

10. The partition assembly of claim 8, wherein the leading end cover is movable relative to the jamb plate between a first position and a second position, and wherein the leading end cover is biased to the first position.

11. The partition assembly of claim 10, further comprising a sensor configured to detect when the leading end cover moves from the first position toward the second position.

12. The partition assembly of claim 8, wherein at least a portion of the leading end cover at least substantially entirely covers a leading surface of the jamb plate.

13. The partition assembly of claim 6, wherein the leading surface of the leading end cover is substantially flush with end surfaces of the two walls when at least substantially all of the movable partition is in the storage position within the storage pocket.

14. The partition assembly of claim 6, further comprising at least one latch mechanism for latching the leading end structure to at least one of another wall and another leading end structure when the moveable partition is in an extended position.

15. The partition assembly of claim 6, wherein the partition assembly does not include a separate cover member for covering an opening to the storage pocket.

16. A method of installing a movable partition assembly in a building, the method comprising:
constructing two opposing and at least generally parallel walls extending between a floor and a ceiling to define a storage pocket therebetween;
positioning at least a trailing end of a movable partition within the storage pocket;
forming a leading end structure and sizing and shaping a leading surface of the leading end structure to at least substantially cover an opening to the storage pocket; and
attaching the leading end structure at a leading end of the movable partition.

17. The method of claim 16, further comprising forming a barrier with the leading end assembly substantially covering the open end of the storage pocket.

18. A method of using a movable partition, the method comprising:
storing a movable partition at least substantially entirely within a storage pocket; and
at least substantially entirely covering an opening to the storage pocket with a leading end structure coupled to a leading end of the movable partition.

19. The method of claim 18, wherein at least substantially entirely covering the opening to the storage pocket with the leading end structure comprises at least substantially entirely covering the opening to the storage pocket with an at least substantially planar portion of the leading end structure.

20. The method of claim 18, further comprising:
at least substantially automatically moving a portion of the movable partition out from the storage pocket; and
at least substantially automatically sensing relative movement between a jamb plate of the leading end structure and a leading end cover of the leading end structure.
